(19) United States
(12) Patent Application Publication
(10) Pub. No.: US 2015/0330564 A1
(43) Pub. Date: Nov. 19, 2015

(54) METERING DEVICE AND METHOD FOR METERED DISPENSING OF A LUBRICATING GREASE ONTO A SURFACE

(71) Applicants: Tobias Mueller, Kraichtal (DE); Stefan Schuermann, Walldorf (DE)

(72) Inventors: Tobias Mueller, Kraichtal (DE); Stefan Schuermann, Walldorf (DE)

(73) Assignee: SKF LUBRICATION SYSTEMS GERMANY GMBH, Walldorf (DE)

(21) Appl. No.: 14/711,072

(22) Filed: May 13, 2015

(30) Foreign Application Priority Data
May 14, 2014 (DE) 10 2014 209 101.2

(51) Int. Cl. F16N 27/02; F16N 25/00

(52) U.S. Cl. CPC F16N 27/02; F16N 25/00

(57) ABSTRACT

A metering device for metered dispensing of a lubricating grease onto a surface includes at least one nozzle configured to dispense the lubricating grease in a given direction and a metering chamber fluidly connectable with a lubricating-grease reservoir and configured to portion the lubricating grease. The metering chamber is configured to hold the lubricating grease, at a location upstream of the nozzle, at an excess pressure without the lubricating grease being dispensed at the nozzle.

### CROSS-REFERENCE

This application claims priority to German patent application no. 10 2014 209 101.2 filed on May 14, 2014, the contents of which are fully incorporated herein by reference.

### TECHNOLOGICAL FIELD

Exemplary embodiments relate to a metering device for the metered dispensing of a lubricating grease onto a surface, a method for metered dispensing of a lubricating grease onto a surface, and a drilling rig (oil rig, oil platform) including the metering device.

### BACKGROUND

Surfaces can be greased or provided with a lubricating grease for a wide variety of reasons including reducing frictional resistance between the surfaces and/or increasing a corrosion protection for a surface. The surfaces can be disposed on all types components and can have different shapes. The surface can be, for example, a body, threads at a connection point between two threaded components, a gear, a gear wheel, a guide element, a bearing, or the like.

A number of very different approaches can be employed for dispensing lubricating grease. For instance, grease or lubricant can be dispensed manually, for example, using a brush or a spray can; however, it can be difficult to meter the lubricant accurately using such a method, and the metering may depend on the skill of the operator. Alternately, a lubricating grease can be automatically applied using an appropriate device. Depending on the application or environment in which the device is used, however, the application device can be subjected to very different requirements for operational reliability/safety/security. Elaborate measures must often be taken to meet these requirements, especially in severe environments.

In addition to the need to precisely meter the lubricating grease, methods and devices for dispensing a lubricating grease onto a surface are subject to a variety of further requirements, for example, with respect to reliability and simplicity of construction.

### SUMMARY

These needs are addressed by embodiments of the present disclosure.

Exemplary embodiments are directed to a metering device for the metered dispensing of a lubricating grease onto a surface. The metering device includes at least one nozzle that is configured to dispense the lubricant in a directed manner (in a given direction). The metering device also comprises a metering chamber fluidly connectable with a lubricating-grease reservoir. The metering chamber is also configured to portion the lubricating grease and to hold the medium (i.e., the lubricating grease) at an excess pressure (above ambient) opposite the nozzle (at a location spaced from the nozzle). In other words, a body of the lubricating grease at a location fluidly separated from the nozzle is subjected to an excess pressure in a manner that does not cause the lubricating grease to exist the nozzle without some further action being taken. Excess pressure opposite the nozzle thus may refer to subjecting the lubricating grease to excess pressure at a location upstream from and fluidly separable from the nozzle.

Since the lubricating grease in the metering chamber is subjected to an excess pressure opposite the nozzle, in some exemplary embodiments the lubricating grease can be dispensed in a metered manner with high operational reliability and high operational safety. For example, the dispensing or distributing can be possible without propellant gas, i.e. without using a propellant gas or compressed air. Furthermore, in some exemplary embodiments the metering device can have a simple structure, and further mechanisms for aiding dispensing can be omitted. The metering device can potentially also be configured to function without the need for a centrifuge to distribute the lubricating grease.

The lubricating grease can be a pasty lubricating grease, for example, a lubricating oil or a thickener. A nozzle can be a component that is formed to uniformly distribute a liquid substance, namely the lubricating grease. Furthermore, the nozzle may be configured to transform a pressure in a medium into a movement energy of the medium. In some cases the nozzle can have a tapering cross-section for this purpose, in order to increase a speed of a medium or of a fluid in the nozzle. A dispensing or atomizing/spraying may be a fine and/or uniform distributing, or also a spraying of a liquid in fine droplets, for example, as an aerosol or mist in a gas, usually air. Under certain circumstances a directed dispensing or atomizing can occur in a targeted manner; that is, the lubricating grease can possibly be applied in the form of a line. The directed atomizing of a medium can differ from a dispensing of a medium via a centrifuge. Using the nozzle the dispensing can optionally be centrifuge-free, i.e. possible without using a centrifuge. A portioned (metered) quantity of the lubricating grease can be a partial quantity of the total quantity of lubricating grease available in the lubricating-grease reservoir.

In addition, in some exemplary embodiments the metering device comprises a metering piston configured to subject the lubricating grease in the metering chamber to an excess pressure. Under certain circumstances the metering piston can be disposed and configured to subject only the lubricating grease in the metering chamber to the pressure. For example, despite the operation of the metering piston an already-metered quantity of the lubricating grease can remain unchanged. In some exemplary embodiments the lubricating grease can be metered very precisely and such that pressure changes do not change the metered amount of the lubricating grease.

Additionally or alternatively, in some exemplary embodiments the metering device comprises a closure element (e.g., a valve) configured to controllably and selectably fluidly separate the metering chamber from the nozzle. In some exemplary embodiments the lubricating grease in the metering chamber can be subjected to an excess pressure without causing it to exit from the nozzle. In other words, the valve can controllably and selectably place the metering chamber and the nozzle into fluid communication.

The driving of the metering piston and/or of the closure element can be hydraulic. Since the driving of the two elements or one of the elements is effected hydraulically, in some exemplary embodiments an operational reliability, in particular with regard to a risk of explosion, can be increased (that is, the risk of explosion can be decreased). For this reason the metering device may be suitable for use on a drilling rig or in other applications where the risk of explosion (e.g., from sparks produced by an electric motor) is present.

Additionally or alternatively, in some exemplary embodiments the metering device comprises a sensor configured to detect the surface onto which the lubricating grease is to be dispensed. According to the exemplary embodiments the metered dispensing can thus be effected automatically. A dispensing of the lubricating grease may be allowed to occur only if a surface to be lubricated is in fact located in a correct position with respect to the metering device and/or the nozzle.

Exemplary embodiments further relate to a method for a metered dispensing of a lubricating grease onto a surface, which method includes introducing the lubricating grease into a metering chamber in a portioned manner. The lubricating grease in the metering chamber is subsequently subjected to an excess pressure opposite a nozzle without the lubricating grease being dispensed at the nozzle. The lubricating grease is subsequently atomized at the nozzle in a directed manner. Since the lubricating grease in the metering chamber is subjected to an excess pressure opposite the nozzle, in some exemplary embodiments the lubricating grease can be dispensed in a desired metered quantity with a high operational reliability and a low risk of explosion. For example, the dispensing can be accomplished without using a propellant gas or a centrifuge.

In addition, in some exemplary embodiments of the method a fluid connection is provided between the nozzle and the metering chamber. This occurs before the lubricating grease at the nozzle is atomized in a directed manner. In some exemplary embodiments the lubricating grease can thus be prevented from exiting at the nozzle when subjected to an excess pressure.

Additionally or alternatively, in some exemplary embodiments, in order to atomize or dispense the lubricating grease at the nozzle a metering piston of the metering chamber is hydraulically moved when the fluid connection exists. In some exemplary embodiments a better and/or finer atomizing of the lubricating grease can thus be achieved.

Under some circumstances, the surface, or the presence of the surface at a location at which lubricant will be dispensed, or a characteristic of a surface onto which the lubricating grease is to be applied can also be detected. In some exemplary embodiments the method can be carried out automatically, and the lubricating grease can be prevented from being dispensed when the surface is incorrectly positioned and/or not present at all.

Additionally or alternatively, the surface onto which the lubricating grease is to be dispensed can be an external thread or a gear. In some exemplary embodiments these components can thus be greased in a targeted manner and with a correctly metered quantity of lubricant. Under certain circumstances an under-application of the lubricating grease can be prevented, and this helps keep wear of the external thread and/or of the gear at an acceptable level. Furthermore, in some exemplary embodiments an over-application of the lubricating grease to the thread or the gear can be prevented, thus reducing or preventing contamination of the external thread or the gear. Furthermore, due to the directed application, in some exemplary embodiments a contamination of the environment around the surface to be lubricated by the lubricating grease can at least be reduced. Optionally the surface, the outer thread, and/or the gear can be a component on a drilling rig.

Exemplary embodiments further relate to a drilling rig including a metering device according to at least one of the above-mentioned exemplary embodiments. For example, the metering device can be used in the context of a drilling device of the drilling rig. Here it can possibly be a metering device on a structure located near where the drill rods are connected to one another via threads. Optionally the metering device can also be a metering device on an adjusting device that serves to adjust the supports for anchoring the drilling rig on the sea floor. Particularly in the application of lubricating grease to surfaces that are located on a drilling rig, a high operational reliability can be desirable, such as can be achievable using the metering device and the method according to exemplary embodiments.

### BRIEF DESCRIPTION OF THE DRAWINGS

The exemplary embodiments and their individual features disclosed in the above description, the following claims, and the accompanying Figures can be meaningfully implemented both individually and in any combination for the realization of an exemplary embodiment in its various designs.

FIG. 1 is a schematic depiction of a circuit diagram of a metering device according to an exemplary embodiment.

FIG. 2 is a schematic depiction of a sectional view of the metering device according to FIG. 1.

FIG. 3 is a schematic depiction of a side view of the metering device according to FIG. 2.

FIG. 4 is a schematic depiction of a front view of the metering device according to FIGS. 2 and 3.

FIG. 5 is a schematic depiction of a sectional view along line B-B of FIG. 4.

FIG. 6 is a schematic depiction of a rear view of the metering device of FIGS. 2 to 5.

FIG. 7 is a schematic depiction of a perspective view of the metering device according to FIGS. 2 to 6 in a first operating state.

FIG. 8 is a schematic depiction of a perspective view of the metering device according to FIGS. 2 to 6 in a second operating state.

FIG. 9 is a schematic depiction of a circuit diagram of a metering device according to a further exemplary embodiment.

FIG. 10 is a schematic representation of a method for the metered dispensing of a grease onto a surface according to an exemplary embodiment.

### DETAILED DESCRIPTION

In the following description of the accompanying Figures, like reference numerals refer to like or comparable components. Furthermore, summarizing reference numerals are used for components and objects that appear multiple times in an exemplary embodiment or in an illustration, but that are described together in terms of one or more common features. Components or objects that are described with the same or summarizing reference numerals can be embodied identically, but also optionally differently, in terms of individual, multiple, or all features, their dimensions, for example, as long as the description does not explicitly or implicitly indicate otherwise.

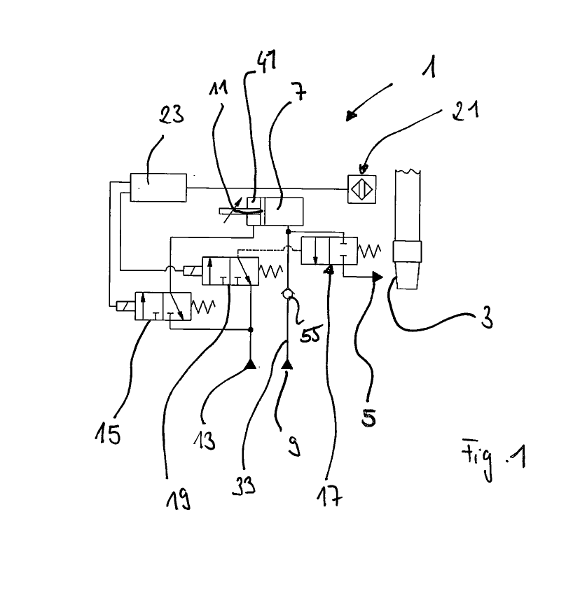

FIG. 1 is a schematic depiction of a circuit diagram of a metering device 1 according to an exemplary embodiment. The metering device 1 is configured for metered dispensing of a lubricating grease (not illustrated) onto a surface 3 and comprises a nozzle 5 configured to dispense or to atomize the lubricating grease in a directed manner. The surface 3 can also be an object to be greased, a body, or a thread. The metering device 1 further comprises a metering chamber 7 configured to be in fluid communication with a lubricating grease reservoir 9. The metering chamber 7 is also configured to portion (hold a defined amount of) the lubricating grease and to subject the lubricant opposite the nozzle 5 to an excess (above ambient) pressure. A check valve is disposed between the lubricating grease reservoir 9 and the metering chamber 7 such that no lubricating grease can flow back from the metering chamber 7 into the lubricating grease reservoir 9, which check valve can also be referred to as medium inlet. The lubricating grease reservoir 9 can also be referred to, for example, as the grease pump that serves to supply the metering device 1 with lubricating grease that is to be dispensed onto the surface 3.

The metering device 1 also comprises a metering piston 11 configured to subject the lubricating grease in the metering chamber 7 to the excess pressure. For this purpose the metering piston 11 is fluidly connected, via a valve 15, to the hydraulic pressure source 13. The valve 15 thus controls the hydraulic pressure applied to the metering piston 11. The hydraulic pressure source 13 can also be referred to as a hydraulic reservoir or a hydraulic pressure side. For example, the hydraulic pressure source 13 may not comprise part of the metering device 1 and may be something provided later or by the customer.

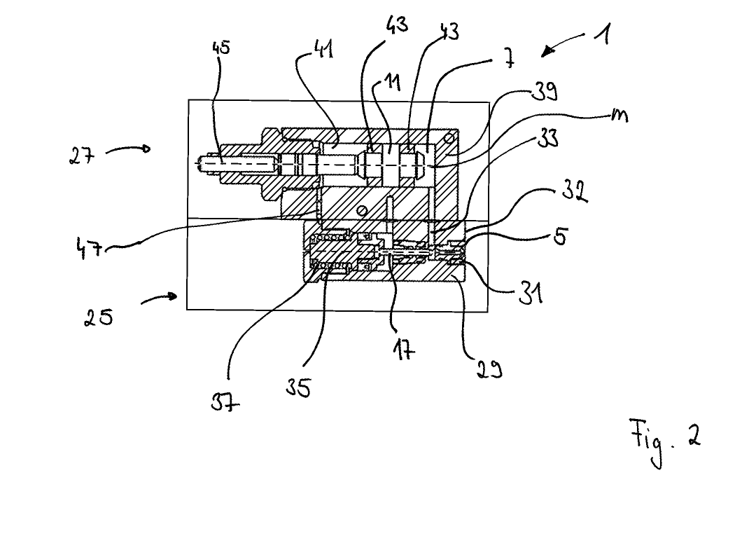

The metering device 1 also comprises a closure element 17, a type of valve, configured to at least partially fluidly separate the metering chamber 7 from the nozzle 5. In some exemplary embodiments the closure element 17 is configured as a nozzle needle, described in more detail below with reference to FIG. 2. The closure element 17 is also operated hydraulically. For this purpose the closure element 17 is also at least partially fluidly connected to the hydraulic pressure source 13. The connection comprises a valve 19 for controlling the opening of the closure element 17 or the nozzle needle.

The metering device 1 further comprises a sensor 21 configured to sense and/or detect the presence of the surface 3. The sensor can be, for example, an inductive, mechanical, magnetic, and/or optical sensor. The sensor should be able to recognize whether the to-be-greased surface 3 is present and/or correctly positioned with respect to the nozzle 5. In some further, not-shown exemplary embodiments, the metering device can also be configured without the sensor.

The metering device 1 also comprises a controlling device 23. The controlling device 23 serves to link the sensor 21 and the two valves 15 and 13 to one another, for example, logically, such that the metering device 1 can be activated only if the surface 3 is detected. Under certain circumstances the controlling device 23 can also comprise a time delay. For example, the controlling device 23 can be a processor, a digital signal processor, a main processor, central processing unit (CPU), a multipurpose processor (MPP) or similar.

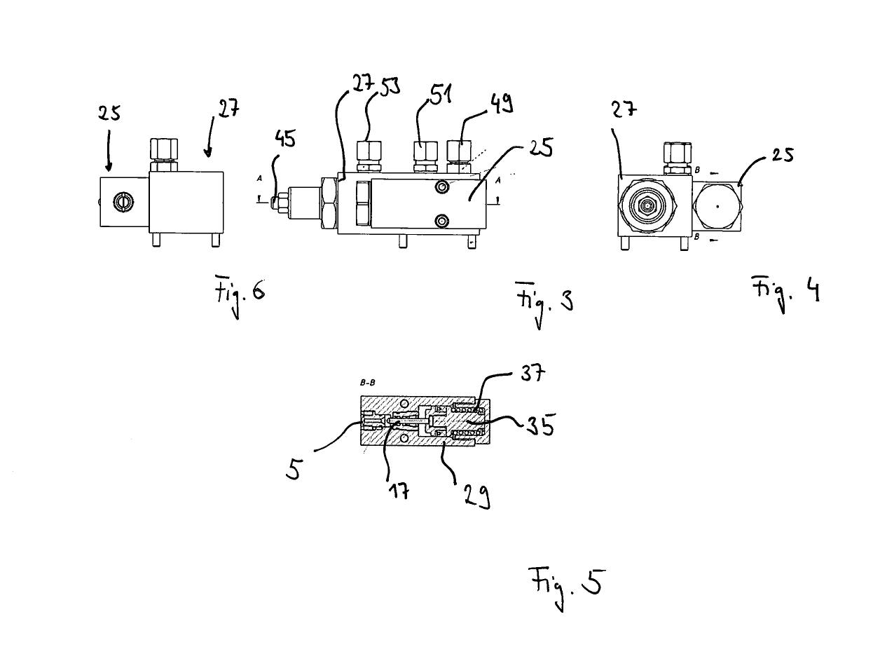

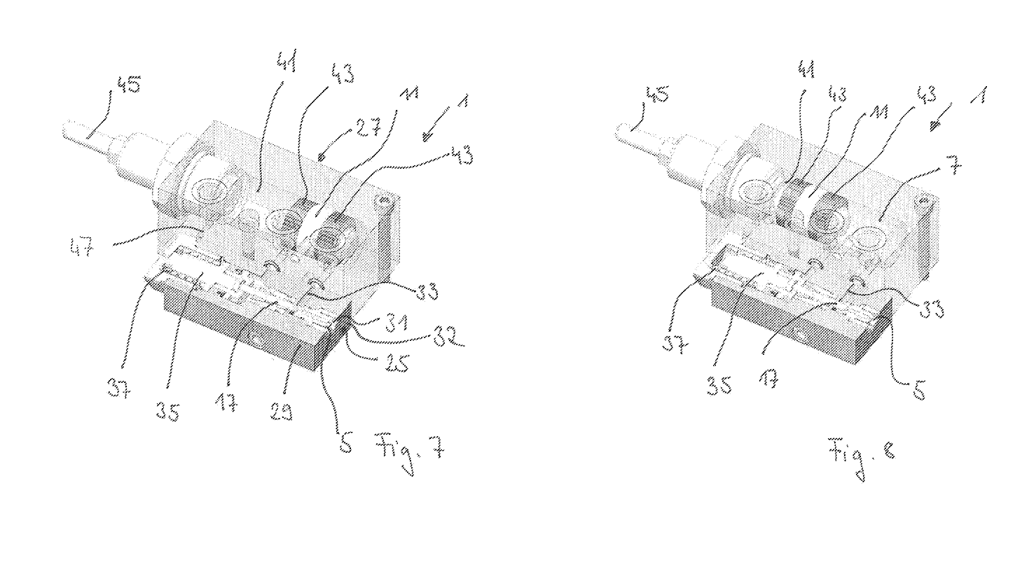

FIGS. 2 to 6 show different views of the metering device 1. As can be seen in FIG. 2, the metering device comprises a nozzle unit 25 and a metering part 27. The nozzle unit 25 comprises a nozzle housing 29 having an opening 31 which opening 31 extends from an end side 32 of the nozzle housing 29 up to a metering channel 33. The metering channel 33 is substantially parallel to the end side 32 or at a 90° angle to the opening 31. The lubricating grease exits the nozzle 5 at the opening 31.

Furthermore, the closure element 17, which is configured as a nozzle needle, is disposed in the nozzle housing 29. The closure element 17 can be moved via a valve piston 35 such that it fluidly separates or isolates the nozzle 5 or the opening 31 from the metering chamber 7. The valve piston 35 is preloaded by a spring element 37 so that when it is not acted on by the hydraulic medium it be brought back into an initial position. The spring element 37 is a spring for closing the closure element 17.

The nozzle unit 25 or the housing 29 is connected to the metering part 27 or a housing 39 of the metering part 27. For this purpose, for example, screw connections can be used. The housing 39 also comprises a part of the metering channel 33 or a bore, which, in an assembled state, connects flush onto the part of the metering channel 33 of the nozzle unit 25. When the metering chamber 7 is not closed by the closure element 17, the metering chamber 7 is in fluid connection (fluid communication) with the nozzle 5 via the metering channel 33. The metering channel 33 can also be referred to as an inlet channel for grease or the lubricating grease, and a connecting channel between the nozzle unit 25 and the metering part 27.

The metering chamber 7 is part of a cylindrical chamber in the housing 39. In some further, not-shown exemplary embodiments, the metering chamber can also have any other shape. The metering piston 11 is inserted into the cylindrical chamber. The metering piston 11 divides the cylindrical chamber into the metering chamber 7 and a chamber 41 for the hydraulic medium. Filling the chamber 41 with the hydraulic medium or removing the hydraulic medium from the chamber 41 causes the metering piston 11 to move. The metering piston 11 is thus configured to fluidly separate the metering chamber 7 and the chamber 41 for the hydraulic medium from each other or to separate the grease or lubricating grease in the metering chamber 7 from the hydraulic medium in the hydraulic chamber 41. The metering piston 11 further comprises at least one, in the present exemplary embodiment two, seal rings 43 that are configured to effect this fluid separation. The two seal rings are disposed such that they seal the metering piston 11 with respect to the wall of the cylindrical chamber.

A stop 45 for the metering piston 11 is provided in the housing 39, and in this embodiment, the stop 45 is movable or adjustable. In the present exemplary embodiment the stop 45 is a threaded pin for adjusting the metered quantity. The piston 11 performs a movement in an axial direction m. The stop 45 is configured to limit the movement along the axis m. A metering adjustment can thus be performed using the threaded pin 45. This limits the stroke of the metering piston 11.

The housing 39 of the metering part 27 further comprises a connecting channel 47, via which the hydraulic space 41 is connected to the hydraulic pressure source 13 or the valve 15. It is thus a connecting channel for the screw connection to the valve 15.

For example, in FIG. 3 a port (fitting) 49 is visible, via which the lubricating grease can be introduced into the metering chamber 7. Furthermore, a port 51 is visible, via which hydraulic fluid for operating the valve piston 35 for moving the closure element 17 can be introduced, and a further port 53 for the channel 47.

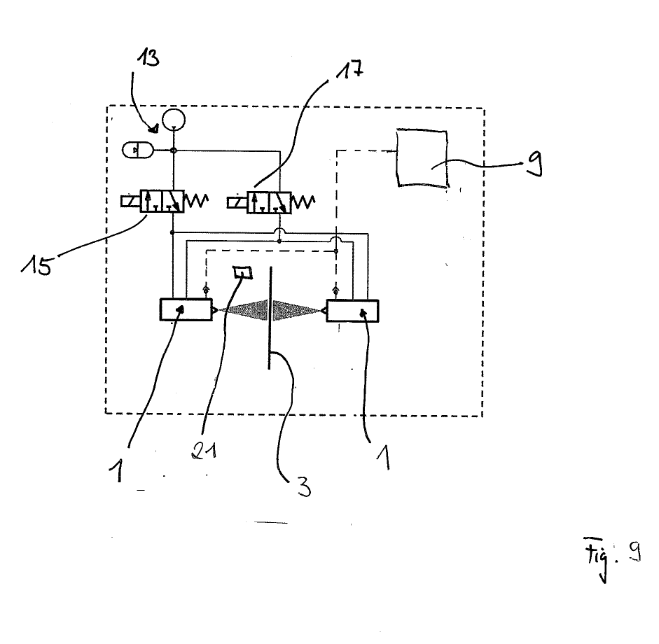

FIGS. 7 and 8 each show a schematic depiction of a perspective view of the metering device 1 according to FIGS. 2 to 6 in different operating states.

FIG. 7 shows a schematic depiction of the metering device 1 in a state in which the closure element 17 or the nozzle needle is open. In this case, the lubricating grease or grease can exit from the metering chamber 7. The valve piston 35 is located in a front end position.

FIG. 8 shows a perspective depiction of the metering device 1 in an initial position. Here the metering chamber 7 in front of the metering piston 11 is filled with the lubricating grease, and the metering piston 11 is preloaded by the hydraulic medium. The nozzle 5 or the metering channel 33 is closed by the closure element 17.

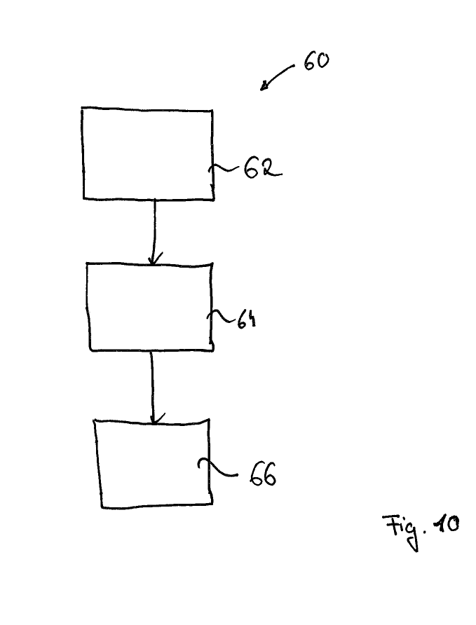

FIG. 9 shows a schematic depiction of a circuit diagram of a system including two metering devices 1 according to an exemplary embodiment. In this case a combination of the nozzle unit 25 and the metering part 27 according to the sectional view in FIG. 2 is represented by the metering device 1.

Each of the metering devices 1 is respectively connected to the lubricating-grease reservoir 9 via conduits represented by dashed lines. The metering devices 1 are connected to the hydraulic reservoir 13 via further conduits/lines and respectively via the valves 15 and 17.

In some further, not-depicted exemplary embodiments the system can also comprises a different number of metering devices, for example, one, three, four, or a greater number.

The metering device 1 is thus an automated greasing system for greasing one or more surfaces 3. The system comprises, as one unit, a spray nozzle including an integrated valve, i.e., the nozzle unit 25, and a flanged, adjustable metering part 27. Depending on the exemplary embodiment of the sensor 21 for recognizing the to-be-greased surface 3, additional components of the system can be two valves for controlling the dispensing; the controlling device 23 to link the sensor 21 and the valves 15 and 19; the lubricating grease reservoir 9, which can also be referred to as the grease pump, for supplying the metering device 1 with grease; and a hydraulic pressure source 13. Using the metering device 1, a medium, especially grease, can be applied onto a surface.

In order to prepare metering device 1 for operation, lubricating grease, which is pumped from the pump or the lubricating reservoir 9, flows through a check valve 55 installed in the metering channel 33 in front of the metering piston 11. The metering piston 11 is pushed by the pressure towards the hydraulic chamber 41. The hydraulic medium located in the hydraulic chamber 41 can flow back through the channel 47 and the valve 15 into the tank or to the hydraulic pressure source 13. As soon as the metering chamber 7 is completely filled with the lubricating grease, the pump of the lubricant reservoir 9 is switched off and the valve 15 is brought into its second switch position to increase the pressure in the hydraulic chamber 41. The switching off of the pump or of the hydraulic pressure source 13 is detected by a pressure switch installed on the pump. In this way the lubricating grease located in the metering chamber 7 is subjected to hydraulic pressure. In this way a type of preloading is achieved in the metering chamber 7. If the nozzle needle or the closure element 17, which serves as a valve, opens, the metering piston 11 is pushed towards the metering chamber 7 by the preloading and possibly by the pressure of hydraulic medium in the hydraulic chamber 41. The lubricating grease flows through the metering channel 33 and exits at the nozzle 5. The nozzle needle 17 or the closure element is opened by the valve piston 35, which is moved hydraulically via the control valve 19. When the metering piston 11 has reached its front end position, as depicted in FIG. 7, the valve 19 is brought back into its initial position, and the valve piston 35 and the closure element 17 are brought back into the initial position by the spring element 37. The nozzle 5 is then closed, and the next cycle can begin.

Lubricating grease can be pumped or supplied again from the lubricating-grease reservoir 9 into the metering chamber 7.

In other words, using the spray nozzle 5 lubricating grease can be automatically applied onto the surface or a thread after the object to be greased or the surface 3 has been detected by the sensor 21. For example, one or more metering devices 1 can be installed on a drilling device so that the threads of the drill rods (that is, locations at which the drill rods or extension rods are connected to one another), can be automatically lubricated. For example, using the metering device 1 an external thread can be lubricated. Since the lubricating grease is applied to the external thread, in some exemplary embodiments the amount of time needed for applying can be shortened relative to the time required for applying grease onto an internal thread, since the nozzle need not be sunk into a bore including the internal thread.

Another application of the metering device 1 can be, for example, the lubricating of gear racks on drilling rigs. Under certain circumstances the gear racks or the gears can be used for adjusting the stilts or struts of the drilling rig, structures via which the drilling rig is anchored to a sea floor. Since there may be explosion risks on drilling rigs, explosion protection is often required, and because the metering devices according to exemplary embodiments are completely hydraulic, the risk of explosion caused by a metering device can be reduced or eliminated (ATEX conformity). This can be supported by the choice of suitable materials.

Surfaces, regardless of whether they are cylindrical or flat, can thus be wetted with a defined, preset quantity of a medium or lubricating grease. Since the installation space for the metering device including the nozzle 5 may be limited at an intake location, the control valves 15 and 19 can beneficially be remotely mounted. Furthermore, in some exemplary embodiments the metering device 1 can have a rapid response rate which result from the preloading of the metering piston 11 so that the lubricating grease is dispensable, even without heating, over a wide temperature range.

FIG. 10 shows a schematic depiction of a method 60 for metered dispensing of a lubricating grease onto a surface according to an exemplary embodiment. In a first process 62 the lubricating grease is introduced into a metering chamber in a portioned manner. In a further process 64 the lubricating grease in the metering chamber is subjected to an excess pressure opposite a nozzle without discharging the grease at the nozzle. Subsequently in a process 66 the lubricating grease is atomized at the nozzle.

For this purpose in a further process a fluid connection is made between the nozzle and the metering chamber. This occurs, for example, before the directed atomizing or dispensing in the process 64 and after the subjecting of the lubricating grease to the overpressure in the process 62.

However, the metering device and the method according to exemplary embodiments can be used other than as described for lubricating of threads and gear racks on drilling rigs. In another possible automated greasing system the metering device 1 can be used on transmissions, machine tools, and in other industries, such as mining, service, manufacturing on mobile machines, vehicles or the like.

The exemplary embodiments and their individual features disclosed in the above description, the following claims, and the accompanying Figures can be meaningfully implemented both individually and in any combination for the realization of an exemplary embodiment in its various designs.

In some further exemplary embodiments, features that are disclosed in other exemplary embodiments as device features can also be implemented as method features. Furthermore, features that are implemented in some exemplary embodiments as method features can also optionally be implemented in other exemplary embodiments as device features.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved metering and/or lubricating devices.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Metering device

3 Surface

5 Nozzle

7 Metering chamber

9 Lubricating-grease reservoir/lubricating-grease pump

11 Metering piston

13 Hydraulic pressure source/hydraulic pump

15 Valve element

17 Closure element/Nozzle needle

19 Valve

21 Sensor

23 Controlling device

25 Nozzle unit

27 Metering part

29 Nozzle housing

31 Opening

32 End side

33 Metering channel

35 Valve piston

37 Spring element

39 Housing

41 Hydraulic chamber

43 Seal ring

45 Stop

47 Channel

49 Port

51 Port

55 Check valve

60 Method

62 Process

64 Process

66 Process

m Axial direction

What is claimed is:

1. A metering device for metered dispensing of a lubricating grease onto a surface, the metering device comprising:
at least one nozzle configured to dispense the lubricating grease in a given direction; and
a metering chamber fluidly connectable with a lubricating-grease reservoir and configured to portion the lubricating grease, the metering chamber further being configured to hold the lubricating grease upstream of the nozzle at an excess pressure without the lubricating grease being dispensed at the nozzle.

2. The metering device according to claim 1, further comprising:
a metering piston configured to subject the lubricating grease in the metering chamber to the excess pressure; and
a closure element configured to at least partially fluidly separate the metering chamber from the nozzle.

3. The metering device according to claim 2, including a hydraulic drive operably connected to the metering piston, or to the closure element or to both the metering piston and the closure element.

4. The metering device according to claim 1, further comprising a sensor configured to detect the presence of the surface onto which the lubricating grease is to be dispensed.

5. The metering device according to claim 1, further comprising:
a metering piston configured to subject the lubricating grease in the metering chamber to the excess pressure;
a closure element configured to at least partially fluidly separate the metering chamber from the nozzle;
a hydraulic drive operably connected to the metering piston, or to the closure element or to both the metering piston and the closure element; and
a sensor configured to detect the presence of the surface onto which the lubricating grease is to be dispensed.

6. A method for metered dispensing of a lubricating grease onto a surface comprising:
introducing a portion of the lubricating grease into a metering chamber;
subjecting the lubricating grease in the metering chamber to an excess pressure upstream from a nozzle without the lubricating grease being dispensed at the nozzle; and
directionally dispensing the lubricating grease at the nozzle.

7. The method according to claim 6, further comprising: creating a fluid connection between the nozzle and the metering chamber before controllably dispensing the lubricating grease.

8. The method according to claim 7, including hydraulically moving the metering piston at a time during which the fluid connection exists.

9. The method according to claim 6, further comprising:
detecting the presence of the surface onto which the lubricating grease is to be applied.

10. The method according to claim 9, wherein the surface is an external thread or a gear or a component on a drilling rig.

11. The method according to claim 6, further comprising:
creating a fluid connection between the nozzle and the metering chamber before controllably dispensing the lubricating grease;
hydraulically moving the metering piston at a time during which the fluid connection exists; and
detecting the presence of the surface onto which the lubricating grease is to be applied.

12. A drilling rig including the metering device according to claim 1.

13. A metering device for metered dispensing of a lubricating grease onto a surface, the metering device comprising:
at least one nozzle configured to dispense the lubricating grease in a given direction; and
a metering chamber upstream of the at least one nozzle, the metering chamber being configured to hold a predetermined quantity of the lubricating grease at a pressure greater than an ambient pressure;
a passageway from the metering chamber to the nozzle; and
a valve in the passageway configured to controllably fluidly connect the metering chamber to the nozzle.

14. The metering device according to claim 13, further comprising:
a metering piston configured to subject the lubricating grease in the metering chamber to the pressure.

15. The metering device according to claim 14, including a hydraulic drive operably connected to the metering piston, or to the valve or to both the metering piston and the valve.

16. The metering device according to claim 15, further comprising a sensor configured to detect the presence of the surface onto which the lubricating grease is to be dispensed.
